(19) United States
(12) Patent Application Publication
(10) Pub. No.: US 2005/0141677 A1
(43) Pub. Date: Jun. 30, 2005

(54) Log system for calendar alarms

(76) Inventors: Tarmo Hyttinen, Liimattala (FI); Antti Eskelinen, Jyvaskyla (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/749,872

(22) Filed: Dec. 31, 2003

(51) Int. Cl. H04M 11/04

(52) U.S. Cl. 379/50; 379/47

(57) ABSTRACT

The present invention relates to a method of logging events in an electronic device, a device in which events are logged, a system in which events are logged and a computer program for logging past alarms. The invention is based on the insight that an alarm event is registered in an electronic device (100). The registering of an alarm event could be a consequence of the fact that a user of the device previously has entered, via an input device (101), data for setting an alarm in the device. The alarm event is stored in a list (300) in a device storage (105). Consequently, the entire list, or a portion of it, can be presented to the device user via a device display (103). The alarm event can relate to a number of different alarm types. For example, the alarm can relate to a reminder, an indication in the calendar of the phone, the activation of a wake-up alarm, etc.

### TECHNICAL FIELD OF THE INVENTION

The present invention relates to a method of logging events in an electronic device, a device in which events are logged, a system in which events are logged and a computer program for logging past alarms.

### BACKGROUND ART

In mobile phones, PDAs, communicators and the like that are employed today, there typically exists a log system for calls and short messages, which log system indicates the lengths of calls, date and time of missed and received calls, dialed numbers and short messages, status of the sent messages, e.g. whether they are delivered or pending, subject of the messages, etc. Typically, there also exists an inbox, an outbox and an archive for messages, as well as a calendar function.

When alarm functionality is employed in a mobile phone, a user of the phone has typically set the alarm, and the phone activates the alarm at the time at which the alarm was set by the mobile phone user. Often, the user carries the phone in a bag, in a pocket in his jacket or trousers or somewhere else where the user, when reaching for the phone, accidentally presses a mobile phone key other than the “stop alarm” key or the “snooze” key. After having pressed a key other than these two designated alarm keys, there is no indication whether the alarm has been turned off or snooze has been activated.

Another situation is when “silent mode” has been activated on the mobile phone, i.e. the phone is typically completely quiet; the ringing signal is not activated, no sound indication is given when a key is pressed, the sms signal is not activated, etc. In the silent mode, alarms are not effected, but automatically snoozed and thereby deferred to a future instant of time. After switching from silent mode to normal mode, the user has to check for alarms having occurred during silent mode from the mobile phone calendar, or wait until the snoozed alarm reoccurs.

The situations given above are disturbing for the mobile phone user and clearly, it is desirable that a solution is provided to the given alarm problems.

### SUMMARY OF THE INVENTION

According to the present invention, a log system for alarms in an electronic device is envisaged, which system provides a solution to the above given problems.

This is attained by a method of logging events in an electronic device according to claim 1, a computer program in accordance with claim 9, a device in which events are logged in accordance with claim 10 and a system in which events are logged according to claim 18.

According to a first aspect of the invention, a method is provided in which an alarm event that relates to a past alarm is registered in the device. Thereafter, the registered alarm event is stored in a list in a device storage. Further, at least a portion of the list of registered alarm events is presented to a user of the device.

According to a second aspect of the invention, a computer program is provided, which program comprises computer-executable components for causing a device to perform the steps recited in the method of the present invention when the computer-executable components are run on a microprocessor included by the device.

According to a third aspect of the invention, a device is provided, which device comprises a microprocessor arranged to register an alarm event that relates to a past alarm in the device. The device further comprises a memory arranged to store the registered alarm event in a list, and a display arranged to present at least a portion of the list of registered alarm events to a user of the device.

According to a fourth aspect of the invention, a system is provided comprising a first device in accordance with claim 10 and a second electronic communication device arranged to receive information from said first device.

The invention is based on the insight that an alarm event is registered in an electronic device such as a mobile phone, a personal digital assistant (PDA), a laptop or the like. In the following, though this by no means limits the scope of the invention, the electronic device will be a mobile phone. The registering of an alarm event in the mobile phone could be a consequence of the fact that a user of the mobile phone previously has entered data for setting an alarm in the mobile phone. This could, for example, has been effected via an input device of the mobile phone such as a keypad or a touch screen, but also via speech, if the mobile phone provides for such a function. When the user is alerted by the alarm and accidentally presses a key on the keypad, for example the key marked “5”, the alarm is stopped. In the prior art, a user is given no indication whether the alarm has been turned off or a snooze function has been activated. To overcome this, the alarm event that relates to the past alarm is stored in a list in a storage of the mobile phone. Consequently, the entire list, or a portion of it, can be presented to the mobile phone user. The list of alarm events is presented to the user, for example via the display of the mobile phone. Note that the alarm event can relate to a number of different alarm types. For example, the alarm can relate to a reminder, an indication in the calendar of the phone, the activation of a wake-up alarm, etc.

The present invention is advantageous, since the user in a smooth and structured manner is provided with an overview of past and future alarms. Moreover, the user is provided with an overview of snoozed alarms, which is advantageous since the user does not need to wait for the snoozed alarm to reoccur, but can cancel the alarm, if desired.

According to an embodiment of the invention, the status of the alarm that corresponds to a registered event is stored in the list, as well as the status of future alarms. This is advantageous, since the user can check the status of the alarm corresponding to a registered alarm event. From the list of alarm events, it can be seen at what time the alarm went off, if the alarm has been disable or if it has been snoozed. In the case it has been snoozed, the time of reoccurrence can be checked. It is also feasible for the user to be able to check the status of future alarms, for which no alarm event yet has been registered.

According to another embodiment, the user can edit the list of registered alarm events and future alarms presented to him. He can, via the mobile phone input device, e.g. a keypad, delete and/or rearrange the registered alarm events, the eventual alarms that are still active (i.e. snoozed alarms) and that relates to the registered alarm events, future alarms that still have not occurred, etc. He can also add new future alarms to the list.

According to a further embodiment of the present invention, the list of alarm events can be transferred from the device via a cable or a wireless connection to a receiving means. The wireless transfer can be effected in a number of ways, for example via an IR port of the device or by employing a radio transmitter of the device, in case it is equipped with such a capability, for example in the case the device is a mobile phone. The receiving means can be a mobile phone, a PDA, a laptop, etc. It is possible that the list of events is transferred to a receiving means in which the list can be edited and then sent back to the device for storing. It might be advantageous to be able to transfer the list to a receiving device that can facilitate the editing of the list and then send the edited list back to the device.

Further features of, and advantages with, the present invention will become apparent when studying the appended claims and the following description. Those skilled in the art realize that different features of the present invention can be combined to create embodiments other than those described in the following.

### BRIEF DESCRIPTION OF THE DRAWINGS

A number of embodiments of the present invention will be described in detail with reference made to the accompanying drawings, in which:

FIG. 1 shows a mobile phone in which the present invention advantageously can be employed;

FIG. 2 shows a flow chart of actions taken when an alarm occurs in accordance with an embodiment of the present invention;

FIG. 3 shows an exemplifying embodiment of a list in accordance with the present invention;

FIG. 4 shows a continuation of the flowchart of FIG. 2, wherein further actions are taken in accordance with the present invention; and

FIG. 5 shows a system of electronic communication devices, in which the present invention advantageously can be employed.

### DESCRIPTION OF EMBODIMENTS OF THE PRESENT INVENTION

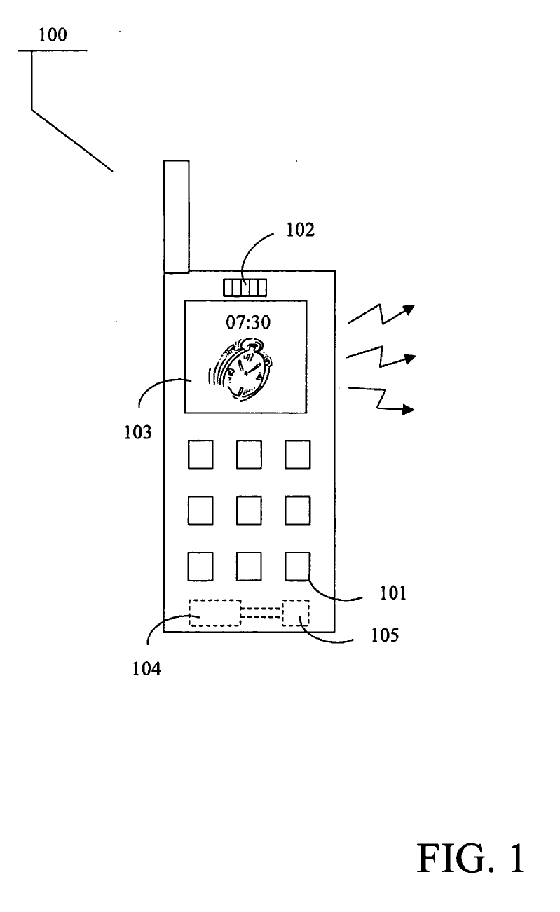

FIG. 1 shows a mobile phone 100 in which the present invention advantageously can be employed. As FIG. 1 shows, an alarm which has been set to 07:30 is activated. Alarm data is entered by the user via a mobile phone input device, typically a mobile phone keypad 101. The alarm sounds via a speaker 102 of the mobile phone. It is also possible that the user is alerted by the alarm via a vibrator in the phone.

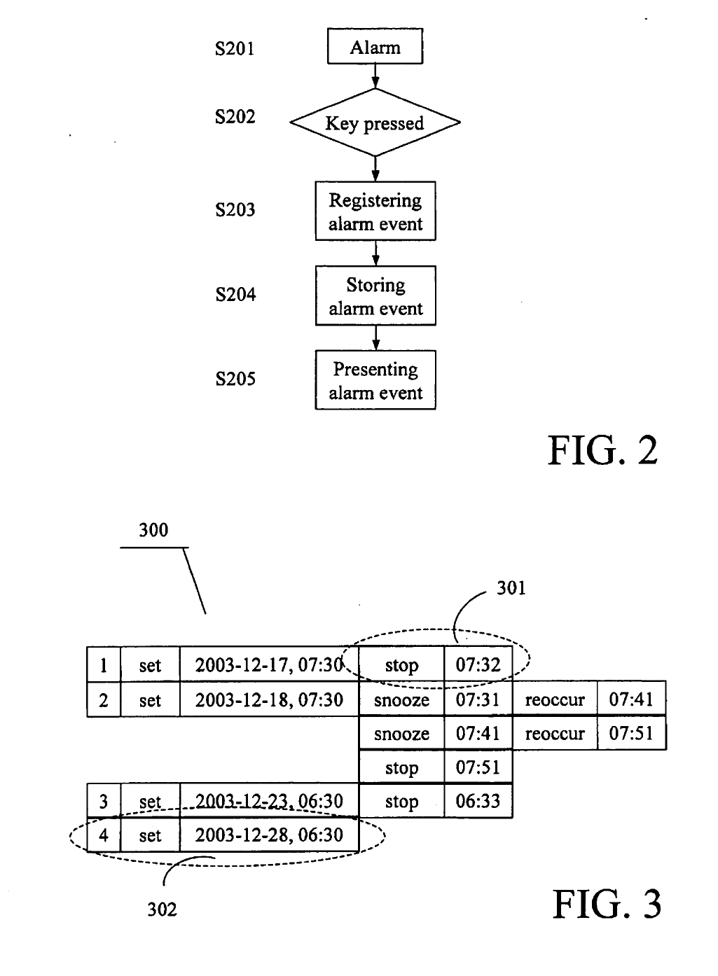

FIG. 2 shows a flow chart of actions taken when an alarm occurs. When the alarm goes off (indicated at S201), the user normally has three options; press “stop” key, press “snooze” key or press any other key on the mobile phone keypad, this is indicated at S202. If the user of the mobile phone presses the “snooze” key or any key other than the “stop” key, the alarm is snoozed. The alarm event, e.g. that the alarm was stopped and the time at which it was stopped, is registered S203, and stored S204, in a list 300 (shown in FIG. 3) in the mobile phone. If the user of the mobile phone snoozes the alarm, the alarm event, i.e. when the alarm was snoozed and when it is to reoccur, is registered S203 and stored S204 in the list of the mobile phone. The actual time when the alarm was set to be activated, which time previously has been input by the user, is also stored in the list. When the user desires to survey the alarm events, he can operate the keypad 101 to manoeuvre the list 300 shown to him on a display 103 of the mobile phone 100. The actions taken in FIG. 2 (apart from step S202, which is taken by the user) are typically effected by a microprocessor 104 and corresponding software in the mobile phone. Equivalent processing means may be used instead of the microprocessor. These equivalent processing means comprise, for example, ASICs, FPGAs, CPLDs, etc. In the list, future alarms are also stored, such that the user in a structured way has all alarms and past alarm events assembled in one place. The list is typically stored in a memory 105 connected to the processor. The memory also stores the software executed by the processor.

FIG. 3 shows an exemplifying embodiment of a list 300 in accordance with the present invention. The alarms and alarm events can be arranged chronologically, as is indicated by the numbering in the leftmost column. The list further shows the date and time at which the alarm was set. Alarm number 1 was set to 17 Dec. at 07:30. As can be seen in the list, this alarm was stopped at 07:32.

Alarm number 2 was set to 18 Dec. at 07:30. It was snoozed a first time at 07:31. It was scheduled to reoccur at 07:41. The frequency of reoccurrence is typically set to a default value of e.g. 10 minutes and can be altered by the user. When alarm number 2 occurred again at 07:41, it was snoozed a second time at 07:41. The third time the alarm occurred, it was stopped at 07:51. Alarm number 4 has not yet been activated, as there is no past alarm event for that particular alarm in the list.

According to an embodiment of the invention, the status 301 of an alarm that corresponds to a registered alarm event, and the status 302 of future alarms, is stored in the list 300.

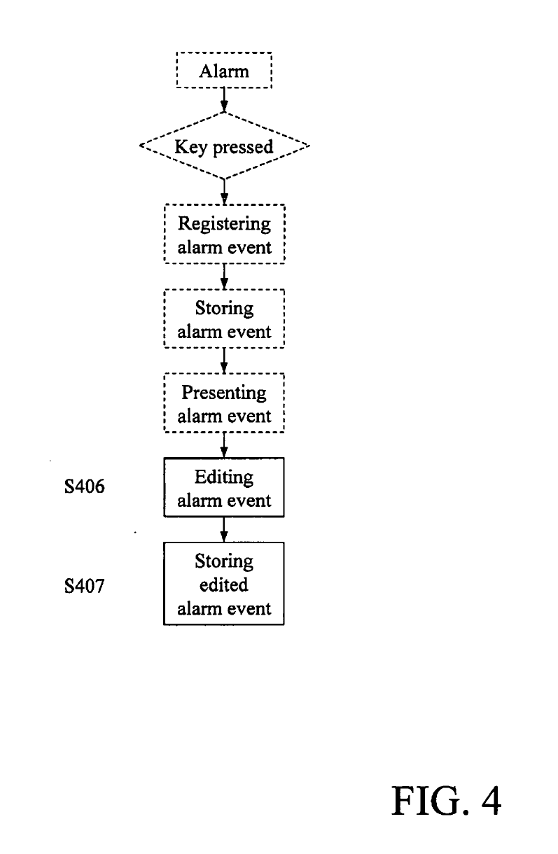

FIG. 4 shows a continuation of the flowchart of FIG. 2. The first five steps are identical, but at S406 the user edits, via the keypad 101 of the mobile phone 100, the list 300 shown to him on the mobile phone display 103. This editing can e.g. comprise the step of deleting a row from the list. For example, row 1 of FIG. 3 relates to a past alarm, which the user may find to be of no relevance any more. The edited list is stored S407 in the device and can be presented to a user when desired.

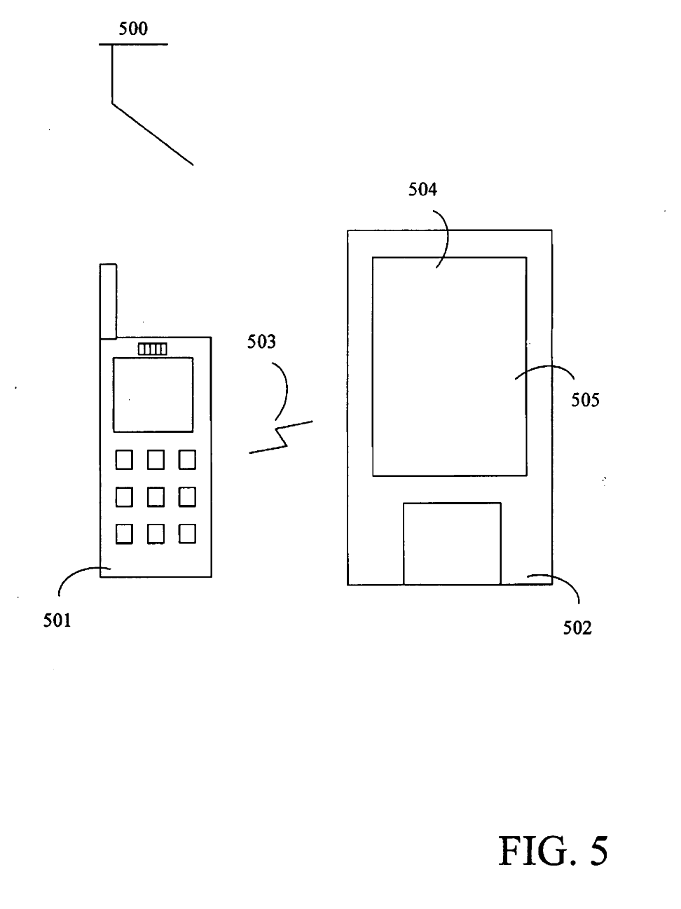

With reference made to FIG. 5, a system 500 is described comprising at least one device 501, e.g. the mobile phone in FIG. 1, according to the present invention and a second electronic communication device 502, e.g. a PDA, arranged to receive information from the device according to the invention. The list 300 can be transferred from the mobile phone 501 to the PDA 502, on which the list may stored, presented and/or edited. Due to the size of the mobile phone, and in particular the mobile phone keypad, the user may prefer to process the list to another type of device, such as the PDA, which the user may find easier to operate. The list can be transferred using a standard interface 503, such as a radio interface, an infrared interface, a Bluetooth or a cable interface. The PDA 502 is arranged with a display 504 via which the list of alarm events is presented to the user. The PDA is further arranged with an input device 505, which in the case of a PDA also happens to be the display, via which the user can edit the list.

Note that the present invention advantageously can be applied in other types of electronic devices, such as a PDA or a laptop. The present invention is not limited to embrace mobile phones only, which is the type of device that happens to be illustrated and described in the embodiments, but also other suitable device types.

Thus, even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A method of logging events in an electronic device (100), the method comprising:
registering (S203) an alarm event that relates to a past alarm in the device;
storing (S204) the registered alarm event in a list (300) in a device storage (105); and
presenting (S205 at least a portion of the list of registered alarm events to a user of the device.

2. The method according to claim 1, wherein the step of storing (S204) the registered alarm event in a list (300) in a device storage (105) comprises:
storing the status (301) of an alarm that corresponds to a registered alarm event, and the status (302) of future alarms, in the list.

3. The method according to claim 1, further comprising the step of:
allowing (S406) a user to edit said list (300).

4. The method according to claim 3, wherein the editing (S406) of said list (300) is performed via an input device (101) of the device (100).

5. The method according to claim 1, wherein the alarm event relates to a past alarm selected from the group comprising a reminder, an indication in a calendar and a wake-up alarm.

6. The method according to claim 1, wherein the list (300) of alarm events is presented to a device user via a display (103) of the device (100).

7. The method according to claim 1, further comprising:
transferring the list (300) of events from the device (100) via a cable or a wireless connection to a receiving means.

8. The method according to claim 1, wherein the device (100) is a mobile phone.

9. A computer program comprising computer-executable components for causing a device (100) to perform the steps recited in claim 1 when the computer-executable components are run on a microprocessor (104) included in the device.

10. A device (100) in which events are logged, which device comprises:
a microprocessor (104) arranged to register an alarm event that relates to a past alarm in the device;
a memory (105) arranged to store the registered alarm event in a list (300); and
a display (103) arranged to present at least a portion of the list of registered alarm events to a user of the device.

11. The device (100) according to claim 10, wherein the memory (105) is further arranged to store the status (301) of an alarm that corresponds to a registered alarm event, and the status (302) of future alarms, in the list (300).

12. The device (100) according to claim 10, wherein the microprocessor (104) is further arranged for allowing a user to edit said list (300).

13. The device (100) according to claim 12, wherein the device is arranged with an input device (101) via which the user can edit said list (300).

14. The device (100) according to claim 10, wherein the alarm event relates to a past alarm selected from the group comprising a reminder, an indication in a calendar and a wake-up alarm.

15. The device (100) according to claim 10, wherein the device is arranged with a display (103) via which the list (300) of alarm events is presented to a device user.

16. The device (100) according to claim 10, wherein the device is further arranged to transfer the list (300) of events via a cable or a wireless connection to a receiving means.

17. The device (100) according to claim 10, wherein the device is a mobile phone.

18. A system (500) in which events are logged, the system comprising:
a first device (501) in accordance with claim 10 and a second electronic communication device (502) arranged to receive information from said first device.

19. The system (500) according to claim 18, wherein the first device (501) is further arranged to transfer the list (300) of events via a cable or a wireless connection (503) to said second device (502).

20. The system (500) according to claim 18, wherein said second device (502) is arranged with a display (504) via which the list (300) of alarm events is presented to a user of the second device, and which second device is further arranged with an input device (505) via which the user can edit said list.
